(19) United States
(12) Patent Application Publication
(10) Pub. No.: US 2009/0176447 A1
(43) Pub. Date: Jul. 9, 2009

(54) AIR SHOWER ROOM

(75) Inventors: XIAN-JUN YUAN, Shenzhen City (CN); XIN LIU, Shenzhen City (CN); JIA ZHANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/194,619

(22) Filed: Aug. 20, 2008

(30) Foreign Application Priority Data
Jan. 4, 2008 (TW) 97100303

(51) Int. Cl. B08B 5/02

(52) U.S. Cl. 454/187

(57) ABSTRACT

An air shower room (100) is connected to a clean room (200). The air shower includes a door (101), a floor (103), two side walls (104), an exit (111) and an interior ceiling (105). The door, the floor, two side walls and the ceiling defines the inside of the air shower room, and the exit lead from the shower room to the clean room. An air curtain machine (109) is positioned in the inside of the air shower room adjacent to the exit, and the floor of the air shower room is higher than the floor of the clean room.

### BACKGROUND

1. Field of the Invention

The present invention relates to air handling equipment, particularly, to air handling equipment used in air shower rooms.

2. Description of Related Art

In some manufacturing and scientific research facilities, clean rooms, free of dust and pollutants are usually required for performing operations. In order to prevent the clean room from contamination, clean room personnel often wear sanitized garments, gloves and booties when working in the clean room.

In addition, air shower rooms are also used to remove dust particles from the clean room personnel prior to their entering the clean room. However, most conventional air shower rooms have low cleaning efficiencies. Some dust particulates may still enter and contaminate the clean room.

Therefore, there is room for improvement within the art.

### BRIEF DESCRIPTION OF THE DRAWINGS

Many aspects of the present air shower room can be better understood with reference to the following drawings. The components in the drawings are not necessarily drawn to scale, the emphasis instead being placed upon clearly illustrating the principles of the present air shower room. Moreover, in the drawings, like reference numerals designate corresponding parts throughout the several views, in which:

FIG. 1 shows a front layout of an air shower room connected to a clean room;

FIG. 2 is similar to FIG. 1, but viewed from a back side; and

FIG. 3 is a cross-sectional view of the air shower room connected to the clean room.

### DETAILED DESCRIPTION OF THE EMBODIMENTS

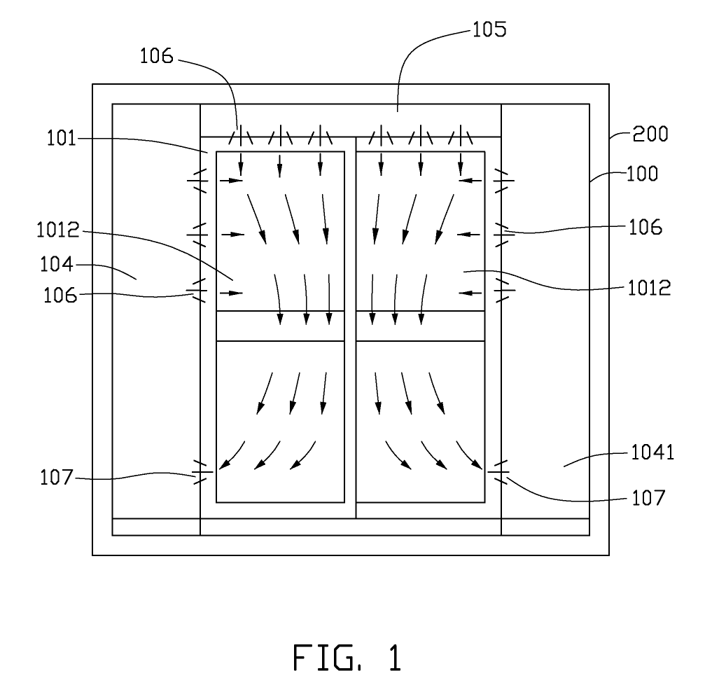

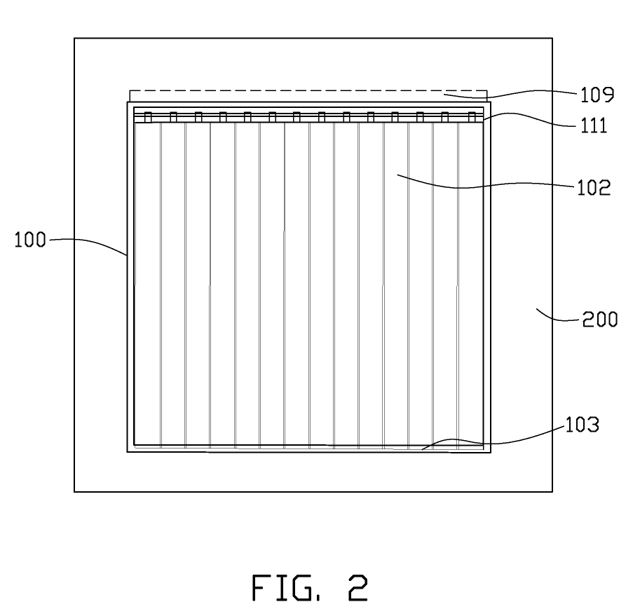

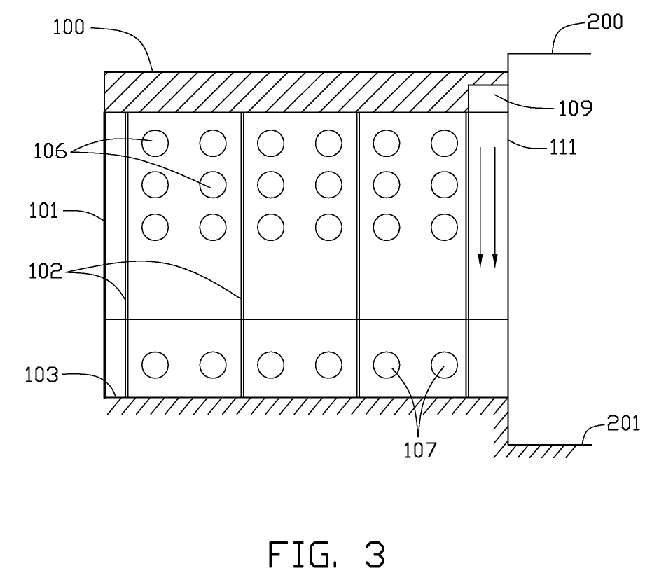

Referring to FIGS. 1 to 3, an exemplary air shower room 100 is shown. One side of the air shower room 100 is connected to a clean room 200. The air shower room 100 is used for removing dust particles from a clean room personnel prior to entering the clean room 200. The clean room 200 has a floor 201.

The air shower room 100 includes an automatic door 101, a floor 103, two side walls 104 and a ceiling 105. The door 101, the floor 103, two side walls 104 and the ceiling 105 cooperatively define the inner space of the air shower room 100. A plurality of transparent anti-static curtains 102 are also positioned at multiple locations in the air shower room 100.

The automatic door 101 is an entrance of the air shower room 100 and has a button (not shown) to open/activate the door 101. When a worker needs to enter the air shower room 100, he/she may press the button to open the door 101. The door 101 closes automatically after a worker enters the air shower room 100. Transparent windows 1012 are formed on the door 101 allowing the inside of the air shower room 100 to be seen.

The two side walls 104 and the ceiling 105 have a plurality of air nozzles 106. The air nozzles 106 on the ceiling 105 inject high velocity air flow towards the floor 103. The air nozzles 106 on the two side walls 104 inject high velocity air flows towards a center of the room 100. The injected air from the nozzles 106, creates a vortex that blows off excessive particles from the person's body.

A bottom portion 1041 of the side walls 104 has a plurality of air vents 107. The high velocity air flow from the air nozzles 106 blows off the excessive dust particles, which may flow out of the air shower room 100 through the air vents 107.

The transparent anti-static curtains 102 are arranged in a number of spaced rows, e.g. four, each row hung from the ceilings 105. The anti-static curtains 102 are arranged to span from one side of the air shower room 100 to the other side of the air shower room 100. Therefore, the static curtains 102 divide the air shower room 100 into a number of separate areas. Each anti-static curtain 102 may eliminate static electricity from a person. In addition, when a worker passes through number of separate area, the anti-static curtains 102 of each separate area may block dislodged particles from entering the next curtained area, thereby achieving a better dust-removing effect.

The air shower room 100 has an exit 111. Adjacent to the exit 111 of the air shower room 100, an air curtain machine 109 is positioned in the ceiling 105. The air curtain machine 109 blows high velocity air downwardly from the ceiling 105 towards the floor 103 to form an air curtain. The floor 103 typically has a very smooth, metal conductive surface. Since the surface of the floor 103 has a very low friction, high velocity air can easily remove dust particles from the surface of the floor 103. Furthermore, the floor 103 is higher than the floor 201 of the clean room 200, for example, at least more than 5 centimeters. Due to the height difference between the floor 103 and the floor 201, the downward high velocity air flow creates a back air flow towards the inside of the air shower room 100. Therefore, the back flow may suck dust particles back again into the air shower room 100.

An infrared sensor (not shown) is positioned in one side wall 104 adjacent to the door 101. The infrared sensor is used for controlling the air nozzles 106. The sensor detects the presence of workers in the room 100 and activates the air nozzles to start blowing air. When the air shower room 100 is not in use, the infrared sensor deactivates the air nozzles 106 to be shut off/stop working.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An air shower room connected to a clean room, the air shower comprising:
a door, a floor, two side walls, an exit and a ceiling, the door, the floor, two side walls and the ceiling defining the inside of the air shower room; the exit leading from the shower room to the clean room;
an air curtain machine positioned inside of the air shower room adjacent to the exit, the floor of the air shower room being higher than the floor of the clean room.

2. The air shower room as claimed in claim 1, further comprising a plurality of anti-static curtains hung from the ceiling and arranged to divide the air shower room into a number of separate areas.

3. The air shower room as claimed in claim 2, wherein two sides of the anti-static curtains are arranged to span from one side of the air shower room to the other side of the air shower room.

4. The air shower room as claimed in claim 1, further comprising a plurality of air nozzles, wherein the air nozzles are positioned in at least one of the ceiling and the two side walls.

5. The air shower room as claimed in claim 4, further comprising a plurality of air vents, the air vents positioned towards a bottom portion of at least one of the two side walls.

6. The air shower room as claimed in claim 1, wherein the floor of the air shower room is about 5 cm higher than the floor of the clean room.
